(19) United States
(12) Patent Application Publication
(10) Pub. No.: US 2006/0114933 A1
(43) Pub. Date: Jun. 1, 2006

(54) Method of transporting an IP packet over a RapidIO network

(76) Inventors: Douglas L. Sandy, Chandler, AZ (US); Michael K. Burgess, Mesa, AZ (US); Mark S. Lanus, Tempe, AZ (US)

Correspondence Address: MOTOROLA, INC., LAW DEPARTMENT, 1303 E. ALGONQUIN ROAD, SCHAUMBURG, IL, 60196, US

(21) Appl. No.: 11/000,665

(22) Filed: Dec. 1, 2004

(51) Int. Cl. H04J 3/22; H04J 3/16; H04L 12/56; H04L 12/28

(52) U.S. Cl. 370/466; 370/400

(57) ABSTRACT

A method of transporting an IP packet (136) from a receiving RapidIO node (102) over a RapidIO network (112) to a destination RapidIO node (104) includes the RapidIO domain receiving the IP packet and reading a destination IP address (273) of the IP packet, where the destination IP address corresponds to the destination RapidIO node. The receiving RapidIO node creates at least one RapidIO packet (135) and maps the destination IP address of the IP packet to a destination node ID (283) of the at least one RapidIO packet The destination node ID is placed into a RapidIO header (280) of the at least one RapidIO packet and at least a portion of the IP packet is encapsulated in the at least one RapidIO packet. The at least one RapidIO packet is communicated to the destination RapidIO node over the RapidIO network.

### BACKGROUND OF THE INVENTION

Internet Protocol (IP) is the world's most popular open-system (nonproprietary) protocol suite because it can be used to communicate across any set of interconnected networks and is equally well suited for LAN and WAN communications. RapidIO is a packet-switched system level interconnect intended primarily as an intra-system interface allowing chip-to-chip and board-to-board communications at Gigabyte per second transfer speeds.

The prior art does not provide a means to transport ubiquitous IP packets over the chip-centric RapidIO network. This has the disadvantage in that local networks using RapidIO must translate packetized data between the RapidIO and IP protocols to interface with the longer-haul IP networks. This has the disadvantage of increasing costs and slowing network operation.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a computer network according to one embodiment of the invention;

FIG. 2 depicts an IP packet encapsulated into a RapidIO packet according to an embodiment of the invention;

FIG. 3 depicts an IP packet de-encapsulated from a RapidIO packet according to an embodiment of the invention; and

FIG. 4 illustrates a flow diagram of a method of the invention according to an embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

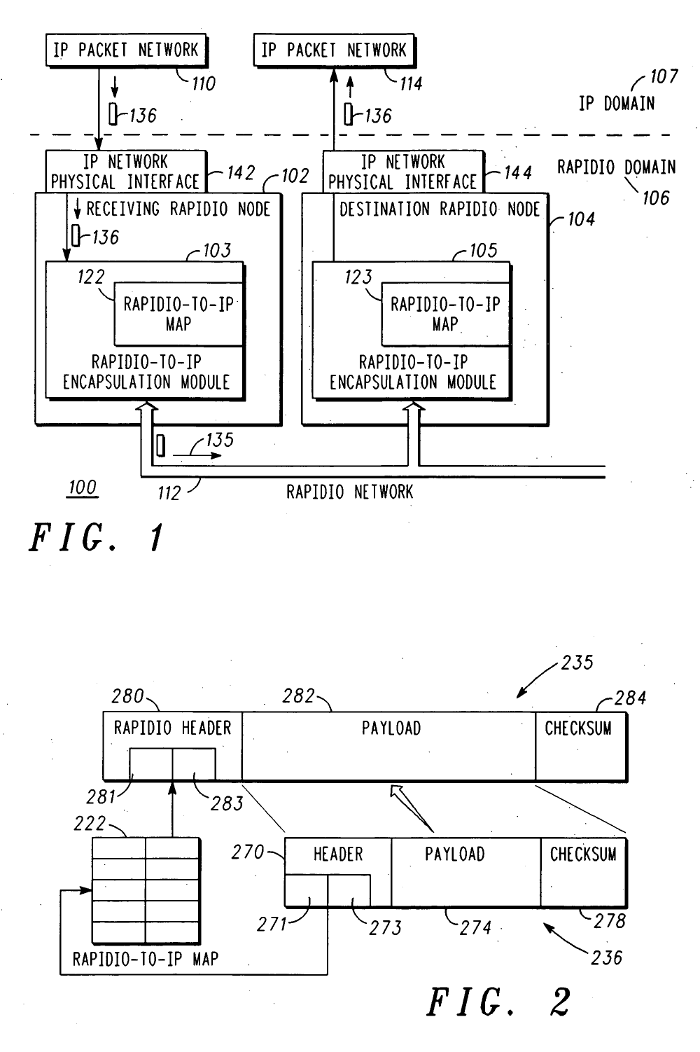

FIG. 1 depicts a computer network 100 according to one embodiment of the invention. Computer network 100 can include one or more IP packet networks 110, 114. Coupled to a RapidIO domain 106. IP packet network 110, 114 can operate using a suite of communication protocols known in the art, of which the two best known are the Transmission Control Protocol (TCP) and the Internet Protocol (IP). The Internet protocol suite not only includes lower-layer protocols (such as TCP and IP), but also can specify common applications such as electronic mail, terminal emulation, and file transfer.

The Internet Protocol is a network-layer protocol that contains addressing information and some control information that enables packets to be routed. IP is the primary network-layer protocol in the Internet protocol suite. Along with the Transmission Control Protocol, IP represents the heart of the Internet protocols. IP has two primary responsibilities: providing connectionless, best-effort delivery of packets through an internetwork of domains; and providing fragmentation and reassembly of packets to support data links with different maximum-transmission unit (MTU) sizes.

IP packet network 110, 114 can each include a gateway controller that can be used to allow individual nodes or domains coupled to IP packet network 110, 114 to extract their configurations. In an example, gateway controller may not have any information on an individual domain or node coupled to IP packet network 110, 114 until that individual domain or node requests information. An example of gateway controller can be a Dynamic Host Configuration Protocol (DHCP) server. DHCP is an Internet protocol for automating the configuration of computers that use TCP/IP. DHCP can be used to automatically assign IP addresses, to deliver TCP/IP stack configuration parameters such as the subnet mask and default router, and to provide other configuration information for example addresses for printer, time and news servers.

RapidIO™ is designed to be compatible with integrated communications processors, host processors, and networking digital signal processors. RapidIO™ is a high-performance, packet-switched, interconnect technology. The RapidIO interconnect allows chip-to-chip and board-to-board communications at performance levels scaling to ten Gigabits per second and beyond. The RapidIO specification is managed and disseminated through the RapidIO Trade Association and can be found at www.rapidio.org. The RapidIO specification is incorporated herein by reference.

Computer network 100 can include any number of RapidIO domains 106 coupled to one or more IP packet networks 110, 114. By way of example, RapidIO domain 106 can be any board, chassis, network or system that includes one or more RapidIO nodes 102, 104 coupled by a RapidIO network 112. RapidIO node 102, 104 can include, but is not limited to, a processor, memory device, storage device, wireline or wireless communication device, and the like. RapidIO node 102, 104 is coupled to communicate on RapidIO network 112 using RapidIO packets 135. A RapidIO packet 135 is described in the RapidIO specification cited above.

In an embodiment, each RapidIO node 102, 104 is coupled to RapidIO network 112. In an embodiment, RapidIO network 112 is coupled to RapidIO-to-IP encapsulation module 103, 105 which can function to encapsulate and de-encapsulate IP packets 136 in and out of RapidIO packets 135 as explained more fully below. Although RapidIO domain 106 is depicted with two RapidIO nodes, any number of RapidIO nodes is within the scope of the invention. Although RapidIO nodes in FIG. 1 are shown with a RapidIO-to-IP encapsulation module, RapidIO nodes in RapidIO domain 106 do not have to include RapidIO-to-IP encapsulation module. For example, in an embodiment, only RapidIO nodes that are coupled to an IP packet network may include RapidIO-to-IP encapsulation module.

In an embodiment, RapidIO domain 106 can comprise a plurality of RapidIO addresses. RapidIO addresses are only recognizable and readable within RapidIO domain 106 and can include, for example, one or more memory address spaces. For example, RapidIO addresses on RapidIO domain 106 may only be recognizable and relevant to RapidIO nodes 102, 104 coupled to RapidIO network 112 as they reference one or more unique memory address spaces in RapidIO domain 106. As RapidIO addresses are relevant only in a RapidIO domain 106, they generally cannot be used outside of RapidIO domain 106, such as in IP packet network 110, 114.

In an embodiment, IP domain 107 can comprises a plurality of IP addresses, which are only recognizable and readable within IP domain 107. Each IP address for each node or domain coupled to IP packet network 110, 114 can be unique so as to uniquely identify each domain or node, for example RapidIO domain 106 or RapidIO nodes 102, 104 on IP packet network 110 114. As is known in the art, an IP address can be used to uniquely identify a domain or node that is making use of IP packet network 110, 114.

In an embodiment, receiving RapidIO node 102 can include RapidIO-to-IP encapsulation module 103 coupled to RapidIO network 112 and to IP packet network 110. In an embodiment, RapidIO-to-IP encapsulation module 103 can include any combination of hardware, software, and the like. RapidIO-to-IP encapsulation module 103 can function to encapsulate at least a portion of an IP packet 136 into at least one RapidIO packet 135 for transport over RapidIO network 112. RapidIO-to-IP encapsulation module 103 can also function to de-encapsulate at least a portion of an IP packet 136 from at least one RapidIO packet 135 so the IP packet 136 can be communicated over IP packet network 114 or otherwise processed by a device capable of reading IP packets 136.

Destination RapidIO node 104 can also include RapidIO-to-IP encapsulation module 105 that functions to encapsulate and de-encapsulate an IP packet 136 in a manner analogous to that described with reference to RapidIO-to-IP encapsulation module 103 in receiving RapidIO node 102.

In an embodiment, upon power-up or boot-up of computer network 100, RapidIO domain 106 can determine a RapidIO ID map, which can be for example a list of all RapidIO ID's of each of the RapidIO nodes 102, 104 in RapidIO domain 106. In an embodiment, RapidIO ID map can be a list of the RapidIO ID's of all RapidIO nodes 102, 104 capable of sending, receiving, and the like, a RapidIO packet 135.

In an embodiment, also upon power-up or boot-up of computer network 100, each RapidIO node 102, 104 coupled to an IP packet network 110, 114 can request and receive an IP address. The IP address can be used by the IP packet network 110, 114 to direct data to each RapidIO node 102, 104. In one embodiment, it can be the task of a gateway controller to get a functional and unique IP number to each RapidIO node 102, 104 that makes use of an IP packet network 110, 114. In another embodiment, a gateway controller does not assign IP addresses as IP addresses for each of RapidIO nodes 102, 104 can be static or determined at the RapidIO node itself.

Upon receipt of an IP address and the creation of a RapidIO ID map, each RapidIO node 102, 104 can build an RapidIO-to-IP map 122 123. In an embodiment, RapidIO-to-IP map 122, 123 can be a look-up table, database, list, algorithm, and the like. In an embodiment RapidIO-to-IP map 122, 123 for each RapidIO node 102, 104 corresponds each RapidIO node to an IP address. In an embodiment, IP address can be for a single RapidIO node. In another embodiment, the IP address can correspond to a RapidIO domain with multiple RapidIO nodes.

In another embodiment, RapidIO-to-IP map 122, 123 can be created at each respective RapidIO-to-IP encapsulation module 103, 105. The invention is not limited to computer networks having only RapidIO domains and nodes. Computer network 100 can include other domains and nodes coupled to IP packet network 110, 114 that function using a protocol different from RapidIO.

An exemplary embodiment of a method of transporting an IP packet 136 from receiving RapidIO node 102, over RapidIO network 112, to destination RapidIO node 104 will now be described. In an embodiment, IP packet network 110 can generate an IP packet 136 having a destination IP address such that the packet is first received by receiving RapidIO node 102.

IP packet 136 can be received by receiving RapidIO node 102, particularly at IP network physical interface 142 of receiving RapidIO node 102. In an embodiment, IP network physical interface 142 can interface the physical IP media to a physical media of receiving RapidIO node 102. For example, the physical media of IP network 110 can be Ethernet, while the physical media of receiving RapidIO node 102 can be a media different from Ethernet. In an embodiment, destination RapidIO node 104 can include an IP network physical interface 144 that can interface the physical media of destination RapidIO node 104 to IP network 114. In another embodiment, receiving RapidIO node 102 can generate IP packet 136 for encapsulation in at least one RapidIO packet 135. RapidIO-to-IP encapsulation module 103 can read the destination IP address from IP packet 136, where the destination IP address can correspond to destination RapidIO node 104. RapidIO-to-IP encapsulation module 103 can create at least one RapidIO packet 135 and map the destination IP address of IP packet 136 to a destination node ID corresponding to destination RapidIO node 104 using RapidIO-to-IP map 122. RapidIO-to-IP encapsulation module 103 can then place the destination node ID in a RapidIO header of the at least one RapidIO packet 135. At least a portion of IP packet 136 can then be encapsulated in at least one RapidIO packet 135 (as shown and described in FIG. 2 below). Thereafter, at least one RapidIO packet 135 can be communicated to destination RapidIO node 104 over RapidIO network 112.

In an embodiment, upon receipt of at least one RapidIO packet 135 at destination RapidIO node 104, RapidIO-to-IP encapsulation module 105 can de-encapsulate at least a portion of IP packet 136 from at least one RapidIO packet 135. Any data in IP packet 236 can then be processed and utilized by destination RapidIO node 104 or issued to IP packet network 114, which can be different from IP packet network 110.

FIG. 2 depicts at least a portion of an IP packet 236 encapsulated into at least one RapidIO packet 235 according to an embodiment of the invention. FIG. 2 illustrates numerous fields in both an IP packet 236 and a RapidIO packet 235. These are representative and do not encompass the only fields in an IP packet 236 or a RapidIO packet 235. Both IP packet 236 and RapidIO packet 235 can include other fields and be within the scope of the invention. The IP header 270 can include things such as the destination IP address 273, source IP address 271, version, flags, length, and the like. Payload field 274 can include the data being transported by IP packet 236. Checksum 278 can ensure packet integrity.

RapidIO packet 235 can include RapidIO header 280, which can include source node ID 281 and destination node ID 283 to indicate the source and destination of the RapidIO packet 235 respectively. Payload 282 can include the data being transported by RapidIO packet 235, which can include, among other things, IP packet 236. Checksum 284 ensures RapidIO packet integrity.

In an embodiment, IP packet 236 can be received by receiver RapidIO node from an IP packet network or generated by receiver RapidIO node as described above. At least one RapidIO packet 235 can be created by receiver RapidIO node with destination node ID 283 mapped from destination IP address 273 and placed in RapidIO header 280. Mapping can occur using RapidIO-to-IP map 222 in receiving RapidIO node. In an embodiment, source IP address 271 can also be mapped to source node ID 281 using RapidIO-to-IP map 222.

FIG. 3 depicts an IP packet 336 de-encapsulated from a RapidIO packet 335 according to an embodiment of the invention. In the embodiment depicted in FIG. 3, like numbered elements represent like elements as discussed with reference to FIG. 2. In an embodiment, when RapidIO packet 335 arrives at destination RapidIO node, IP packet 336 can be de-encapsulated such that the data carried by IP packet 336 can be processed or utilized by destination RapidIO node, communicated to processing nodes utilizing protocols other than RapidIO, and the like. In an embodiment, IP packet 336, once de-encapsulated, can be communicated on an IP packet network 114.

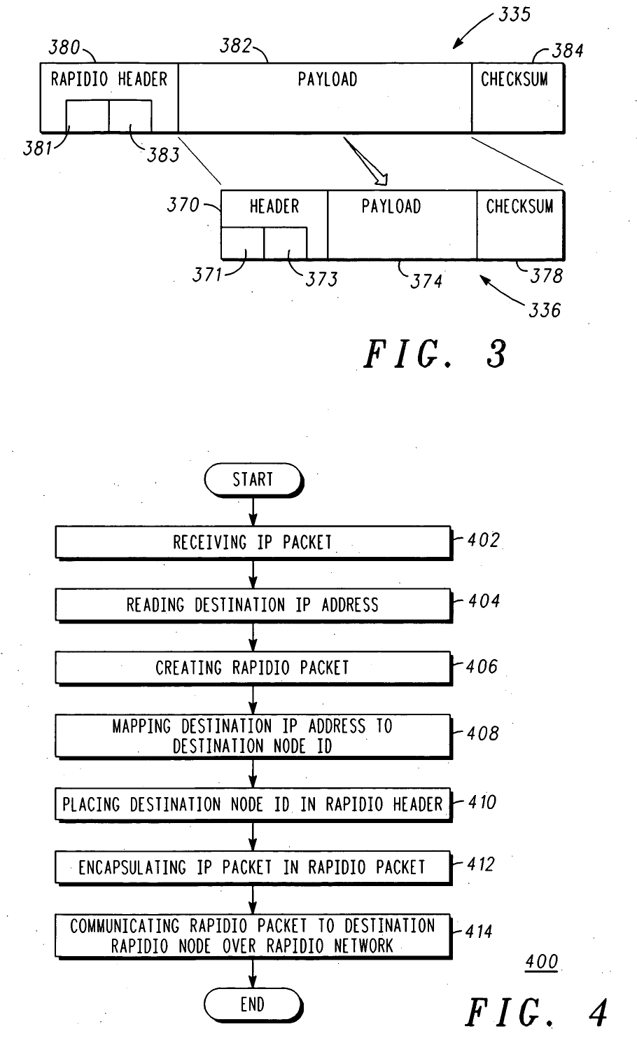

FIG. 4 illustrates a flow diagram of a method of the invention according to an embodiment of the invention. In an embodiment, FIG. 4 sets forth a method of transporting an IP packet from a receiving RapidIO node, over a RapidIO network, to a destination RapidIO node. In step 402, receiving RapidIO node receives an IP packet from an IP packet network. In another embodiment, receiving RapidIO node can generate an IP packet. In step 404, RapidIO-to-IP encapsulation module at receiving RapidIO node reads destination IP address from IP packet. In step 406, at least one RapidIO packet is created by receiving RapidIO node.

In step 408, RapidIO-to-IP map at receiving RapidIO node can be used to map destination IP address to destination node ID. In step 410, destination node ID can be placed in RapidIO header of at least one RapidIO packet. In step 412, at least a portion of IP packet can be encapsulated in the at least one RapidIO packet. In step 414, at least one RapidIO packet can be communicated over RapidIO network to destination RapidIO node.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. In a RapidIO domain, a method of transporting an IP packet from a receiving RapidIO node over a RapidIO network to a destination RapidIO node, comprising:
the receiving RapidIO node receiving the IP packet;
reading a destination IP address of the IP packet, wherein the destination IP address corresponds to the destination RapidIO node;
the receiving RapidIO node creating at least one RapidIO packet;
mapping the destination IP address of the IP packet to a destination node ID of the at least one RapidIO packet;
placing the destination node ID into a RapidIO header of the at least one RapidIO packet;
encapsulating at least a portion of the IP packet in the at least one RapidIO packet; and
communicating the at least one RapidIO packet to the destination RapidIO node over the RapidIO network.

2. The method of claim 1, further comprising:
the destination RapidIO node de-encapsulating the at least a portion of the IP packet from the at least one RapidIO packet; and
issuing the IP packet to an IP packet network.

3. The method of claim 1, further comprising:
mapping a source IP address of the IP packet to a source node ID; and
placing the source node ID into a RapidIO header of the at least one RapidIO packet.

4. A RapidIO domain, comprising:
a RapidIO network; and
a RapidIO-to-IP encapsulation module coupled to the RapidIO network, wherein the RapidIO-to-IP encapsulation module couples the RapidIO domain to an IP packet network, wherein the RapidIO-to-IP encapsulation module is coupled to map a destination IP address of an IP packet to a destination node ID, and wherein the RapidIO-to-IP encapsulation module is coupled to encapsulate at least a portion of the IP packet into at least one RapidIO packet.

5. The RapidIO domain of claim 4, wherein the RapidIO-to-IP encapsulation module is coupled to communicate the at least one RapidIO packet to a destination RapidIO node over the RapidIO network.

6. The RapidIO domain of claim 4, wherein the RapidIO-to-IP encapsulation module is coupled to place the destination node ID into a RapidIO header of the at least one RapidIO packet.

7. The RapidIO domain of claim 4, wherein the RapidIO-to-IP encapsulation module is coupled to map a source IP address to a source node ID and place the source node ID into a RapidIO header of the at least one RapidIO packet.

8. A RapidIO domain, comprising:
a RapidIO network; and
a RapidIO-to-IP encapsulation module coupled to the RapidIO network, wherein the RapidIO-to-IP encapsulation module couples the RapidIO domain to an IP packet network, wherein the RapidIO-to-IP encapsulation module is coupled to de-encapsulate at least a portion of an IP packet from at least one RapidIO packet.

9. In a computer network, a method of communicating an IP packet over a RapidIO network, comprising:
a receiving RapidIO node receiving the IP packet;
reading a destination IP address of the IP packet, wherein the destination IP address corresponds to a destination RapidIO node;
the receiving RapidIO node creating at least one RapidIO packet;
mapping a destination IP address of the IP packet to a destination node ID of the at least one RapidIO packet;
placing the destination node ID into a RapidIO header of the at least one RapidIO packet;
encapsulating at least a portion of the IP packet in the at least one RapidIO packet; and
communicating the at least one RapidIO packet to the destination RapidIO node over the RapidIO network.

10. The computer network of claim 9, wherein a RapidIO-to-IP encapsulation module at receiving RapidIO node encapsulates the at least a portion of the IP packet.

11. In a computer network, a method of communicating an IP packet over a RapidIO network, comprising:
receiving a RapidIO packet over the RapidIO network, wherein the RapidIO packet comprises at least a portion of the IP packet;
the destination RapidIO node de-encapsulating the at least a portion of the IP packet from the RapidIO packet; and
issuing the IP packet to an IP packet network.

12. In a receiving RapidIO node, a method of transferring an IP packet, comprising:
receiving an IP packet;
reading a destination IP address of the IP packet, wherein the destination IP address corresponds to a destination RapidIO node;
creating at least one RapidIO packet;
mapping the destination IP address of the IP packet to a destination node ID of the at least one RapidIO packet;
placing the destination node ID into a RapidIO header of the at least one RapidIO packet;
encapsulating at least a portion of the IP packet in the at least one RapidIO packet; and
communicating the at least one RapidIO packet to the destination RapidIO node over a RapidIO network.

13. The method of claim 12, wherein a RapidIO-to-IP encapsulation module at the receiving RapidIO node encapsulates the at least a portion of the IP packet.

14. In a destination RapidIO node, a method of transferring an IP packet from a RapidIO network, comprising:
receiving a RapidIO packet over the RapidIO network, wherein the RapidIO packet comprises the IP packet;
de-encapsulating the IP packet from the RapidIO packet; and
issuing the IP packet to an IP packet network.

15. The method of claim 14, wherein a RapidIO-to-IP encapsulation module at the destination RapidIO node de-encapsulates the at least a portion of the IP packet.

16. A computer-readable medium containing computer instructions for instructing a processor to perform a method of transporting an IP packet from a receiving RapidIO node over a RapidIO network to a destination RapidIO node, the instructions comprising:
the RapidIO node receiving the IP packet;
reading a destination IP address of the IP packet, wherein the destination IP address corresponds to the destination RapidIO node;
the receiving RapidIO node creating at least one RapidIO packet;
mapping the destination IP address of the IP packet to a destination node ID of the at least one RapidIO packet;
placing the destination node ID into a RapidIO header of the at least one RapidIO packet;
encapsulating at least a portion of the IP packet in the at least one RapidIO packet; and
communicating the at least one RapidIO packet to the destination RapidIO node over the RapidIO network.

17. The computer-readable medium of claim 16, further comprising:
the destination RapidIO node de-encapsulating the IP packet from the RapidIO packet; and
issuing the IP packet to an IP packet network.

18. The computer-readable medium of claim 16, further comprising:
mapping a source IP address of the IP packet to a source node ID; and
placing the source node ID into a RapidIO header of the at least one RapidIO packet.

19. In a RapidIO domain, a method of transporting an IP packet from a receiving RapidIO node over a RapidIO network to a destination RapidIO node, comprising:
the receiving RapidIO node generating the IP packet;
reading a destination IP address of the IP packet, wherein the destination IP address corresponds to the destination RapidIO node;
the receiving RapidIO node creating at least one RapidIO packet;
mapping the destination IP address of the IP packet to a destination node ID of the at least one RapidIO packet;
placing the destination node ID into a RapidIO header of the at least one RapidIO packet;
encapsulating at least a portion of the IP packet in the at least one RapidIO packet; and
communicating the at least one RapidIO packet to the destination RapidIO node over the RapidIO network.

20. The method of claim 19, further comprising:
the destination RapidIO node de-encapsulating the at least a portion of the IP packet from the at least one RapidIO packet.

21. The method of claim 19, further comprising:
the destination RapidIO node de-encapsulating the at least a portion of the IP packet from the at least one RapidIO packet; and
issuing the IP packet to an IP packet network.
